(19) United States
(12) Patent Application Publication
(10) Pub. No.: US 2006/0131382 A1
(43) Pub. Date: Jun. 22, 2006

(54) Apparatus, system, and method for selecting, pricing, and displaying a non-standardized product

(76) Inventor: Michael Thatcher, Layton, UT (US)

Correspondence Address: KUNZLER & ASSOCIATES, 8 EAST BROADWAY, SALT LAKE CITY, UT, 84111, US

(21) Appl. No.: 11/305,404

(22) Filed: Dec. 16, 2005

Related U.S. Application Data
(60) Provisional application No. 60/636,559, filed on Dec. 16, 2004.

(51) Int. Cl. G06F 7/00

(52) U.S. Cl. 235/376

(57) ABSTRACT

An apparatus, system, and method are disclosed for receiving input specified by a consumer, determining a unique product derived from the input, determining a price associated with the unique product, and displaying a visual representation of the unique product and the determined price. The apparatus, system, and method enable the consumer to select a unique product and to view a visual representation of the unique product with the determined price. The apparatus, system, and method further determine a quantity of material required to produce the unique product and an optimal delivery method for delivering the unique product.

### CROSS-REFERENCES TO RELATED APPLICATIONS

This application is a continuation-in-part of and claims priority to U.S. Provisional Patent Application No. 60/636,559 entitled “APPARATUS, SYSTEM, AND METHOD FOR SELECTING, PRICING, AND DELIVERING MATERIALS FOR THE IMPROVEMENT OF PROPERTY” and filed on Dec. 16, 2004 for Michael Thatcher, which is incorporated herein by reference.

### BACKGROUND OF THE INVENTION

1. Field of the Invention

This invention relates to customized product orders and more particularly relates to apparatuses, systems, and methods for selecting, pricing, and viewing a non-standardized product.

2. Description of the Related Art

The selection, pricing, ordering, and shipping of materials for product customization and/or for property improvement has typically been a cumbersome and inefficient process for both the supplier and the consumer. Manufactured parts that require a creative or unusual design or natural materials such as landscape rocks that are by nature unique traditionally have been difficult to standardize and, therefore, difficult to price. Quantifying the amount of material required for completing a product such as a uniquely shaped pool, elements and upgrades for a home or RV, a landscape design, and the like can also be a problem

The usual procedure typically requires a design or construction agent to visit the selected site, perhaps bringing samples, then taking measurements, making calculations and ultimately “getting back” to the customer with an estimate. Alternatively, the customer may bring measurements to a sales and display facility, view samples and selected designs, provide the measurements, and wait for the estimate.

Often the customer is not provided with a visual conception of what the finished product will be like or what is included in the estimate. In addition, that customer is typically not offered alternative options that may be more cost effective or may offer a better quality product or design than what has been selected. Moreover, the customer may be unable to get a quick price estimate for simple design changes, alternative materials, the materials without the labor charges, or a price estimate for delivery.

Unfortunately, the estimates are often imprecise and may be unrealistically low. After the customer agrees to the price and places the order, the actual material amount may be excessive or insufficient to finish the desired product or project. This is particularly a problem for landscaping materials such as topsoil, concrete, rocks, and the like.

Rocks are typically priced and shipped by the truck load, yet no standardization currently exists to establish the size of the truck bed. Too often a customer is left with a low quality or unfinished product and must incur additional expenses to complete or improve the product or project. Alternatively, these costs are born by the contractor or installation company. Large boulders present a further challenge in selection, shipping, and placement, because extra boulders on the job site are not easily removed. Similarly, too few boulders may require a subsequent delivery, which can be expensive and inconvenient.

Furthermore, the quality of material may vary from supplier to supplier. A selected type and color may vary greatly from the actual product. The same problems exist in other areas of property improvement and product customization. After doing the legwork and waiting for an estimate, the customer may be left with unused material or an unfinished product, a greater expense than anticipated, and/or quality that is less than expected.

From the foregoing discussion, it should be apparent that a need exists for an apparatus, system, and method for pricing and displaying a non-standardized product. Beneficially, such an apparatus, system, and method would streamline the selection, pricing, and delivery process of a unique for greater efficiency and convenience both the supplier'and the consumer. In addition, the apparatus, system, and method would enable a customer to select materials, design a product, see an estimated price and visual representation, place an order, and receive a timely and accurate delivery. The apparatus and method would encourage and assist the customer in making decisions regarding a customized product and/or a property improvement project.

### SUMMARY OF THE INVENTION

The present invention has been developed in response to the present state of the art, and in particular, in response to the problems and needs in the art that have not yet been fully solved by currently available suppliers of customized products and pricing and display systems. Accordingly, the present invention has been developed to provide an apparatus, system, and method for pricing and displaying a non-standardized item that overcome many or all of the above-discussed shortcomings in the art.

The apparatus, in one embodiment, is configured to display a visual representation of the unique product and a determined price. In certain embodiments, the visual representation and the price may be updated in real time. The apparatus may include an input module to receive input specified by a consumer, a product module to determine a unique product derived from the input and a price associated with the unique product, and a display module configured to display a visual representation of the unique product and the determined price.

In certain embodiments, the apparatus further includes a quantification module and a labor estimation module. The quantification module determines a quantity of material required in order to produce the unique product, and the labor estimation module estimates a cost for labor. The apparatus is further configured, in one embodiment, to select and price one or more rocks for a landscape design. In a further embodiment, the apparatus is configured to determine an optimal delivery method.

A system of the present invention is also presented to price and display a non-standardized product. The system may be embodied in a computer network. In particular, the system, in one embodiment, includes a computer network, a computer connected to the network, a server to communicate with the computer through the computer network and to search a database, an input module to receive input specified by a consumer, a product module configured to determine a unique product derived from the input and to determine a price associated with the unique product, a display module configured to display a visual representation of the unique product and the determined price, and a monitor configured to display the visual representation of the unique product and the determined price.

A method of the present invention is also presented for receiving input specified by a consumer, determining a unique product derived from the input, determining a price associated with the unique product, and displaying a visual representation of the unique product and the determined price. The method in the disclosed embodiments substantially includes the steps necessary to carry out the functions presented above with respect to the operation of the described apparatus and system. In one embodiment, the method includes determining an optimal delivery method to deliver the unique product. The method also may include determining an alternative product to the unique product and searching a database for material availability and providing an estimate for availability of the unique product.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The present invention simplifies the selection, pricing, and delivery process for a unique, customized product in order to provide greater efficiency and convenience for both the supplier and the consumer. In addition, the present invention enables a customer to select materials, design a product, see an estimated price and visual representation, place an order, and receive a timely and accurate delivery. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for pricing and displaying a non-standardized product in accordance with the present invention;

FIG. 2 is a schematic block diagram illustrating one embodiment of input received into a system for pricing and displaying a non-standardized product in accordance with the present invention;

FIG. 3 is a schematic block diagram illustrating one embodiment of an apparatus for pricing and displaying a non-standardized product in accordance with the present invention;

FIG. 4 is a schematic block diagram illustrating one embodiment of a consumer interface in accordance with the present invention;

FIG. 5 is a schematic block diagram illustrating one embodiment of a product module in accordance with the present invention;

FIG. 6 is a schematic block diagram illustrating one embodiment of a quantification module in accordance with the present invention;

FIG. 7A is a spreadsheet illustrating one embodiment of a custom formula using a plurality of dimension specifications to determine a quantity of rocks in accordance with the present invention;

FIGS. 7B-7C are a spreadsheet illustrating the custom formula of FIG. 7A in greater detail;

FIGS. 8A-8B are a worksheet illustrating one embodiment of a pricing/information list in accordance with the present invention;

FIG. 9 is a schematic block diagram illustrating one embodiment of a labor estimation module in accordance with the present invention;

FIG. 10 is a schematic block diagram illustrating one embodiment of a delivery module in accordance with the present invention; and

FIG. 11 is a schematic flow chart diagram illustrating one embodiment of a method for pricing and displaying a non-standardized product in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

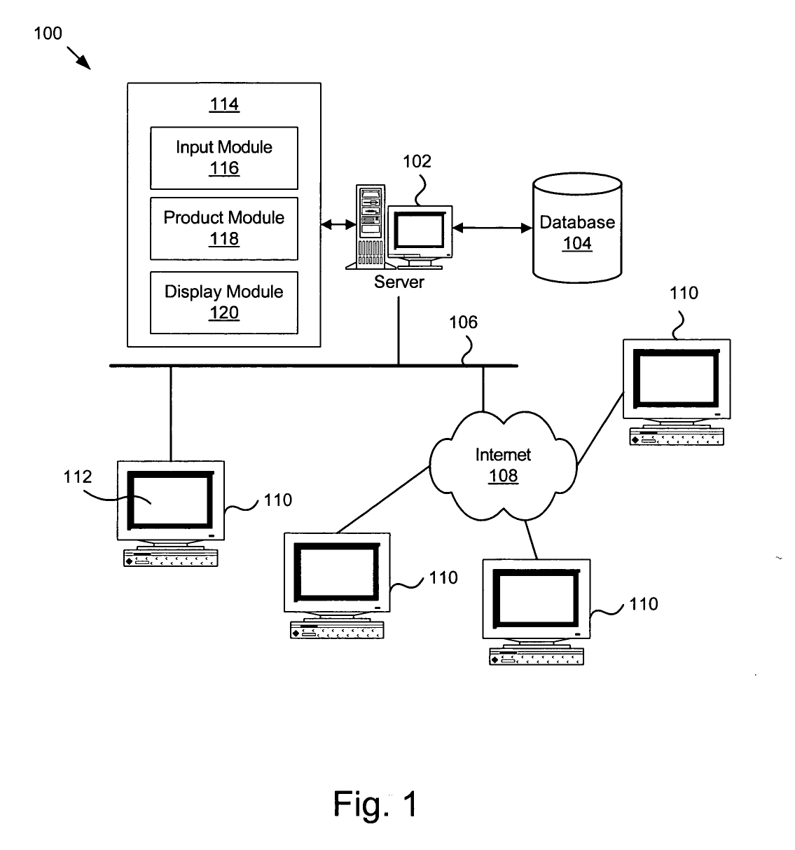

FIG. 1 depicts one embodiment of a system 100 for pricing and displaying a non-standardized product. The system 100 as illustrated includes a server 102, a database 104, a computer network 106, which may include the Internet 108, one or more computers 110, one or more monitors 112, and an apparatus 114 for pricing and displaying the non-standardized product. The apparatus 114 includes an input module 116, a product module 118, and a display module 120. The system 100 enables a consumer to select or create a customized product and to view a visual representation of the product and an associated price on a computer monitor 112.

The server 102 may search the database 104 for data relative to a non-standardized product. In certain embodiments, a product may comprise a single unique item, such as a landscape rock, for example, or a detailed property improvement project, such as a home remodel or a landscape design. A product may include real and non-real property. For example, software may be considered a product that may be priced and represented visually. The word “product” as used herein may represent any good and/or service that a consumer would like to purchase and is not intended to limit the scope of the invention. A product may be produced by human or mechanical effort or by a natural process.

The word “non-standardized” as used herein refers to any product that is generally not standardized for production, such as for production on an assembly line, for example, and does not carry a standard price. A factory-built car or a computer, for example, typically comprises standardized parts that are associated with a standard price. On the other hand, natural materials and products with unique designs or dimensions, for example, typically lack standardization and are relatively priced. The present invention facilitates pricing non-standardized products and simplifies and optimizes the purchasing process.

The server 102 may be accessible to other computers 110 through the network 106 and/or the Internet 108 such as the World Wide Web. Remote users may benefit from the pricing and displaying apparatus 114 through the network 106. In certain embodiments, a visual representation of the non-standardize product may be viewable on a monitor 112. The pricing and displaying apparatus 114 may comprise a graphical interface to communicate with the user and to solicit input from a consumer. The consumer and the user may or may not be the same entity. In certain embodiments, a sale representative or the like may enter a consumer response.

The consumer input may be used to search the database 104 and to determine unique product that corresponds to the specifications provided by the user. An estimated price may be associated with the unique product, and a visual representation may be displayed to the user. The user may have the option to modify the input provided and to continue to search for the product that best suits the consumer's desires. The visual representation and the determined price facilitate the consumer's search for a customized product that is satisfactorily priced.

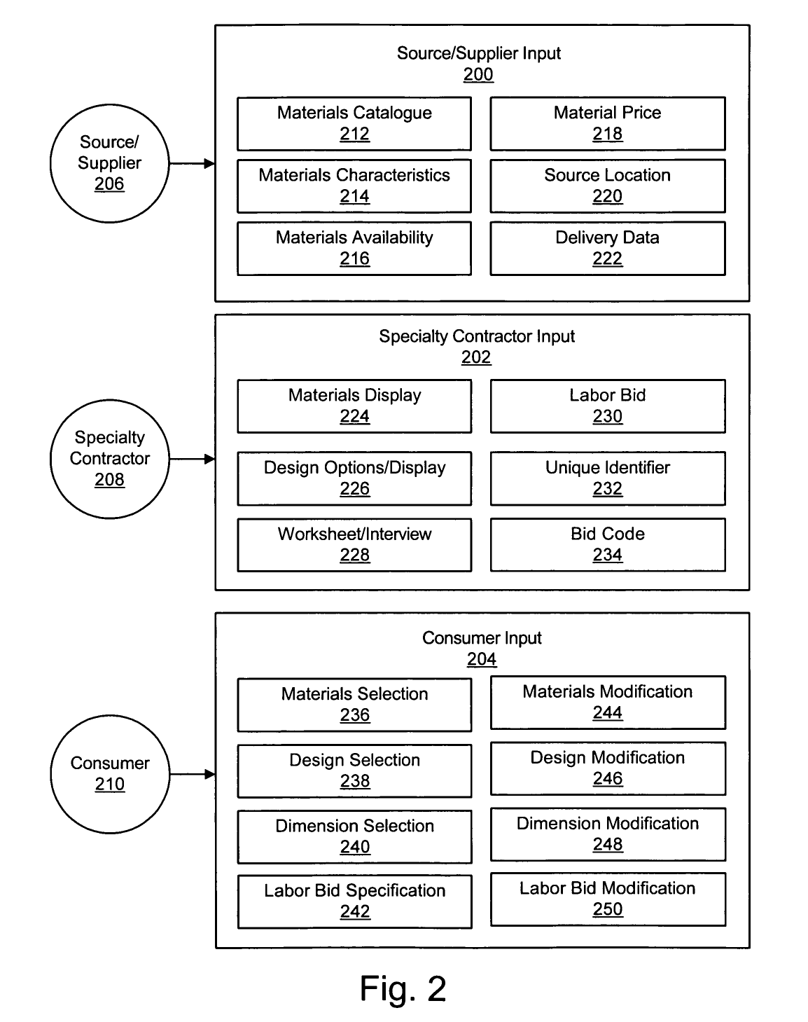

FIG. 2 illustrates one embodiment of examples of input 200, 202, 204, provided by a material source and/or supplier 206, a specialty contractor 208, and a consumer 210. The input 200 and the input 202 may be used to create a searchable database 104 and/or a graphical interface and/or display for providing information and searchable options to a user. The input 204 may be used to search the database 104 and determine a unique product.

The source/supplier 206 may be one or a plurality of entities. For example, a stone quarry or lumber mill might market through a wholesaler or retailer. A single wholesaler or retailer may sell materials from multiple sources, giving consumers 210 a wider selection. Alternatively, a source may market to the public directly.

The source/supplier 206 may provide a materials catalogue 212 or the like with pictures or visual representations of the type of materials available for purchase. The materials catalogue 212 may include variations of a type of material. The materials characteristics 214 may provide a detailed description of the material characteristics. For example, natural materials, such as stone, have characteristics such as general shape, color, hardness, texture, homogeneity, color/shade variation, removal process, weight, flatness, etc., that are unique to each material type.

Materials availability 216 may describe the likelihood of availability. Some materials may be readily available while others may take time to obtain for various reasons such as remote location, shipping difficulties, speed of production, etc. Accurate and detailed information facilitate the selection and purchasing process.

Suppliers 206 may further provide a material price 218. Pricing may vary by shipping load, individual units, weight, size, by the square foot, etc., which may vary according to supplier 206 and/or according to material type.

The source location 220 may also affect the price and availability as well as the method of delivery. Delivery data 222 may facilitate calculating an accurate price, and planning a safe and timely delivery. Delivery data 222 may include a vehicle type and an estimated time for loading, transporting, and delivery. In addition, delivery data 222 may include safety precautions such as risks associated with unloading or moving rocks, measures for preventing erosion, property damage, and the like, suggestions for cleaning an area after delivery, deciding the safest place for delivery, and the like. Delivery may be provided by the source or supplier 206, or by an outside shipping company.

The specialty contractor 208 may be a craftsman, designer, installation company, landscaping company, or the like that provides services associated with the materials. Often times, the specialty contractor 208 produces a product such as a retaining wall, a remodeled room, a swimming pool, or the like from purchased materials. In certain embodiments, the specialty contractor 208 may also be the supplier 206.

In one embodiment, the specialty contractor 208 provides the visual representation of the materials such as a materials display 224. The materials display 224 may include photographs of available materials as well as a description. In one embodiment, the materials display 224 includes multiple photographs of available stone juxtaposed for comparison. In conjunction with the photograph, the display may contain a list of basic characteristics and a simple outline of basic shapes available for that particular stone or material type. A current shade comparison may also be shown to ascertain that the consumer is satisfied with the currently available stone.

Providing one or more visual images may increase the number of opportunities to market a product. For example, displaying a product feature or design that the consumer may not be aware of may convince the consumer to pursue an alternative purchasing strategy. Further, by providing images, the consumer may feel more confident of the product and may be more likely to complete a purchase.

Design options, suggestions, or photographs of recently completed products/projects may be available for user selection and may be included in a design options display 226. Alternatively, basic design options, simple drawings, safety precautions, informative suggestions, a design wizard, or the like may be used to direct a consumer to create a unique design.

The specialty contractor 208 may also provide a worksheet 228 or interview questions to help establish the wants and needs of the consumer. The worksheet 228 maybe used to facilitate determining a unique product as well as an appropriate craftsman to complete the product if needed. In one embodiment, the worksheet 228 asks for personal information such as name and location and then asks questions to define the product or project. To find rocks appropriate for a landscape design, the worksheet 228 may prompt the consumer to pick a color of rock and then to pick a characteristic shape. Next, the consumer may enter suitable dimensions and choose a placement style or design. Information may be provided to suggest rocks with certain shapes for specific placement designs, or to suggest specific rocks for certain dimensions. In addition, safety tips may also be provided.

In one embodiment, rock shapes are associated with a number and are classified according to placement as rock garden or placement rocks, retaining wall rocks, staircase rocks, pavers, and cobble. A square face footage calculator or the like may help the user determine how much rock will be needed for a retaining wall or the like. In one embodiment, a square face footage calculator comprises a chart comparing the length and height of the wall with a corresponding rock size and square footage estimate. In one embodiment, retaining wall options include single or multiple rows with the same height or tapering at one end.

For a selected retaining wall design, the dimensions entered may include the number of rows, the height of the wall on the left end, the height of the wall in the middle, the height of the wall on the right end, the length of the wall, the slope, and the space between the rocks. An illustration may be associated with the rock stacking style, the slope of the retaining wall, the rock shape, the entered dimension, and the space between the rocks in certain embodiments.

A labor bid may 230 be given to provide an estimated price for a selected design. In addition, the specialty contractor 208 may be associated with a unique identifier 232 and/or a bid code 234. The specialty contractor 208 may provide the unique identifier 232 and/or bid code 234 directly to a consumer 210 to receive a specialized estimate. In certain embodiments, the bid code 234 may correspond to a percentage mark up from a base value that is awarded to the specialty contractor 208.

In certain embodiments, the consumer 210, who is the individual or organization purchasing the services provided, may complete a questionnaire or worksheet 228 to guide their initial responses to make a materials selection 236, a design selection 238, a dimension selection 240, and a labor bid specification 242. A product profile maybe made from the initial consumer input 204. The worksheet 228 may or may not be electronic. In a contemplated embodiment, the worksheet 228 or interview is accompanied by visual images. Those of skill in the art will recognize that a product profile may be compiled from any consumer input 204 that would facilitate determining a unique product and/or a property improvement project.

In certain embodiments, a materials modification 244, a design modification 246, a dimension modification 246, and a labor bid modification 250 may be made to the product profile to create a modified product profile. Modifications may be made to a product profile to refine a product to more closely represent the consumer's desired product or price range.

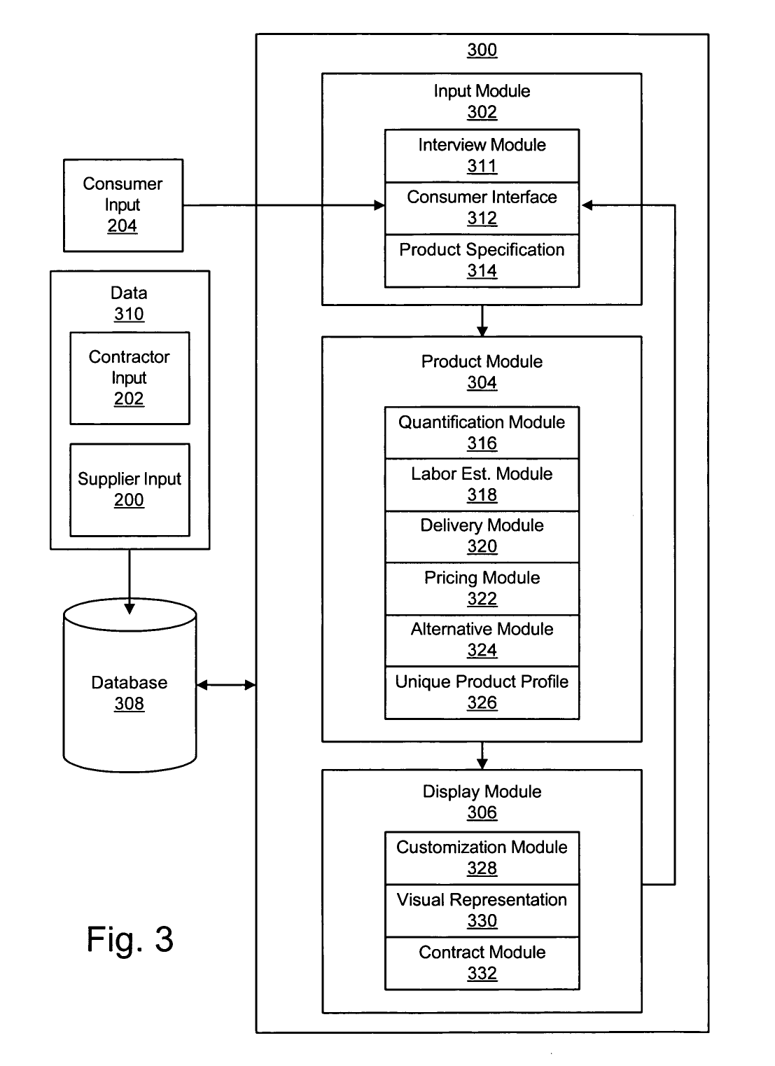

FIG. 3 illustrate one embodiment of an apparatus 300 for pricing and displaying a non-standardized product. The apparatus 300 includes an input module 302, a product module 304, and a display module 306. The apparatus 300 receives consumer input 204 and communicates with a database 308. The database 308 may contain data 310 derived from supplier input 200 and contractor input 202. The apparatus 300 facilitates determining a unique product and displaying a visual representation and a price associated with the unique product.

The input module 302 may include an interview module 311 and a consumer interface 312 for communicating with the user and/or consumer. In certain embodiments, the interview module 311 may interact with the consumer interface 312 to solicit and receive consumer input 204. In one embodiment, the interview module 311 comprises computer hardware or software that interacts electronically with the consumer 210. Alternatively, the interview module 311 may consist of an individual or group, optionally assisted by computer hardware or software, that interacts with the consumer 210 either directly or via a communication device. The interview module 311 may selectively combine pictures, illustrations, graphics, interactive displays and text to logically lead a consumer 210 through the process of planning and designing a product or property improvement project. In one embodiment, the interview module 311 provides worksheets and/or displays to the consumer interface 312.

The consumer interface 312 may comprise an electronic display that includes graphics and/or text. In a contemplated embodiment, the consumer 210 may make textual and/or numerical entries as well as graphical selections for material type and design. The consumer interface 312 may draw data 310 from the database 308 to place images, information, and the like. In one embodiment, the consumer interface 312 comprises a plurality of web pages which may be accessible to computers 110 through the network 106 or the internet 108 such as the World Wide Web and may be viewable with a web browser.

From the received consumer input 204, the input module 302 may compile a product specification 314 in certain embodiments. The product specification 314 may include limitations, dimensions and the like describing a desired product. The product specification 314 may facilitate determining an actual product.

The product module 304 determines a unique product from the input 204 and determines a price associated with the unique product. The product module 304 may include a quantification module 316, a labor estimation module 318, a delivery module 320, a pricing module 322, an alternative module 324, and a unique product profile 326. In addition, the product module 304 may access the database 308 for data 310 supplied by the supplier 206 and the specialty contractor 208.

The quantification module 316 may determine from the product specification 314 the amount of material and type of material required to produce the unique product. For example, if the consumer would like to place concrete in a specified shape and dimension, the quantification module 316 would determine the amount of concrete needed to produce the desired concrete slab. In addition, the quantification module 316 may calculate an estimated price that corresponds to the determined amount of material. The price estimate may correspond to input 200, 202 received from a supplier 206 and/or a specialty contractor 208.

If an assortment of material is required to produce the unique product, the quantification module 304 may determine a quantity required for each type of material and a determined price. For example, if a remodeled bathroom is desired, the quantification module 304 would determine a quantity for each of the materials, such as tile, grout, bathtubs, sinks, cabinets, etc., required to complete the product and may associate a price with each determined quantity.

The labor estimation module 318 estimates a cost for labor required to produce the unique product. For example, if the consumer desired the remodeled bathroom, the product may be associated with a labor bid 230 that estimates the cost for completing the bathroom. The cost for labor may be a flat rate price or may be an hourly estimation for completing the product in certain embodiments. In one embodiment, several labor bids 230 may be associated with the product to enable the consumer to choose a desired labor bid 230.

As mentioned, the labor bid 230 may or may not be associated with a bid code 234 and/or a unique identifier 232. In certain embodiments, the bid code 234 and/or the unique identifier 232 may determine the rate for which a specialty contractor 208 is willing to work. The bid code 234 and/or the unique identifier 232 may also determine the price for materials.

The delivery module 320 determines an optimal delivery method and calculates a cost for delivery of the unique product. The delivery module 320 may determine the transportation method required for the unique material and may determine a delivery route relative to the location of the supplier and the location of the consumer 210. In one embodiment, the delivery module 230 determines an optimal delivery route for delivering multiple products to various consumers, which streamlines the delivery process.

The pricing module 322 may combine the different prices associated with materials, labor, and delivery to create a combined price estimate. The combined price estimate may be displayed to the consumer. Alternatively, the separate prices or a selected combination of the individual prices may be displayed to the consumer. In certain embodiments, the pricing module 322 may determine a minimum order requirement or the like and may inform the user of remaining material. The pricing module 322 may provide the user options, such as how to obtain a different pricing bracket or stage.

The alternative module 324 may determine an alternative product with similar requirements or dimensions to present further options to the consumer. For example, the alternative module 324 may determine a similar product with more refined materials to sell a more expensive product to the consumer. Alternatively, the alternative module 324 may determine a similar product with added safety precautions to present a safer product to the consumer. In one embodiment, the alternative module 324 determines a similar product that can fulfill a minimum order requirement or that can qualify for a different price bracket. The alternative module 324 may guide the user to modify a product specification 314 to avoid certain product limitations, additional expenses, unreasonable requests, or the like.

In one embodiment, the alternative module 324 may provide a more cost effective product. For example, the alternative product may suggest placing landscape rocks farther apart with more space for plantings, selecting a more standard shape for a swimming pool, or installing a less expensive fireplace in a home. The display module 306 may display the alternative product to the consumer 210. In a further embodiment, the customer 112 may interact with the interview module 311 to modify the unique project profile 326.

The unique product profile 326 may identify a product, including the dimension, design, material, modifications, availability, and the associated price. The price may be divided into separate costs for materials, labor, delivery, etc. as described above or presented as a combined estimate. The unique product profile 326 may facilitate displaying the product for purchase to the consumer.

For example, if a consumer 210 views a specialty contractor's 208 display of landscape rock and chooses a particular line of grey granite, the product module 304 may combine the consumer's product specification 314 with the data from the displays to identify the size, shape, source, and quantity of material required. The resulting product profile 326 may include the general class of product, such as a retaining wall; the complete dimensions including length, height, depth, and slope; and the type of rock selected including composition (granite), the color, shape, texture, and the sizes and number of stones required. The product profile 326 may different according to the type and nature of the product selected. For example, the product profile 326 for a software design product would comprise very different specifications, designs, and dimensions.

In a further embodiment the consumer 210 may view only select elements of the product profile 326 in order to serve certain business interests. For example, certain standard market terms such as the quantity and the identification of a specific material type may be withheld to prevent the consumer 210 from using the present invention to obtain a price, quantity, and materials list, and then contacting a different supplier and/or contractor.

The display module 306 displays a visual representation 330 of the unique product and the determined price. In the depicted embodiment, the display module 306 further includes a customization module 328 and a contract module 332. The visual representation 330 may be displayed to the user through the consumer interface 312 in certain embodiments. In one embodiment, the display module 306 may compile a presentation to review the determined product with the consumer.

In one embodiment, the display module 306 interacts with the product module 304 to present one or more graphic representations of the product profile 326, a combined price estimate, and/or an alternative price estimate or profile to the consumer 210. The graphic representations might include, a window displaying the data values for fields located within the product specification 314, a listing of the product specifications, a listing of materials, a graphic mockup of the product or project, and an animation/calculator that dynamically adjusts the price and quantity with project changes in style, slope, shape, or the like.

The customization module 328 may customize a graphic to resemble the unique product. For example, a unique dimension or selected design maybe represented in a customized graphic display. In certain embodiments, the graphic may include the specific dimensions corresponding to the unique product, such as a floor plan, pool dimension, or the like.

Alternatively, a plurality of graphics representing various designs, materials, etc. may be displayed in a visual representation 318. In a contemplated embodiment, the visual representation 330 provides one or more images to inform of the consumer of what to expect from the product or to enable the user to modify the product specification 314. In certain embodiments, a visual representation 318 may accompany a user selection. For example, if the user selects a color of material, a graphic displaying that color may remain on display; if the user selects a design, the design graphic may remain on display, etc., until a visual representation 318 of the selected product remains on display. Alternatively, each selection may be displayed graphically following a product determination.

Subsequently, a contract module 332 may create a legal contract to finalize a purchase. The legal contract may be displayed following the visual representation of the unique product and the determined price. In certain embodiments, the legal contract expresses safety precautions and disclaimers. An animation or graphic icon may be used to draw attention to the important safety precautions.

For example, if a delivery truck is going to be crossing concrete, the user may need to pre-approve this action and waive liability for any damage the action may cause. The contract module 332 may show an icon of a truck and an animation of a truck breaking concrete. If rocks are to be dumped in the road, there is a chance that a rock will scar the street or roll into the curb and break or chip the curb. A suitably designed icon and animation may be used for this as well. Another potential liability risk for which an icon and animation may be used is when a load of rocks is dumped in a pile and a small child could climb up on the rocks. One of the rocks may be unstable and roll, resulting in possible injury. The added icons and/or animations may stress the importance of safety, and the accepted legal agreement may protect the supplier 206 from liability.

The consumer 210 may choose to purchase the displayed product according to the calculated product profile 326. Alternatively, the consumer 210 may select an alternative product or may choose to modify the calculated product profile 326. In one embodiment, the consumer 210 may modifying the product profile 326 by changing the product specification 314 and submitting the modified product specification 314 to the product module 304 in order to determine a modified product and consequently a modified price.

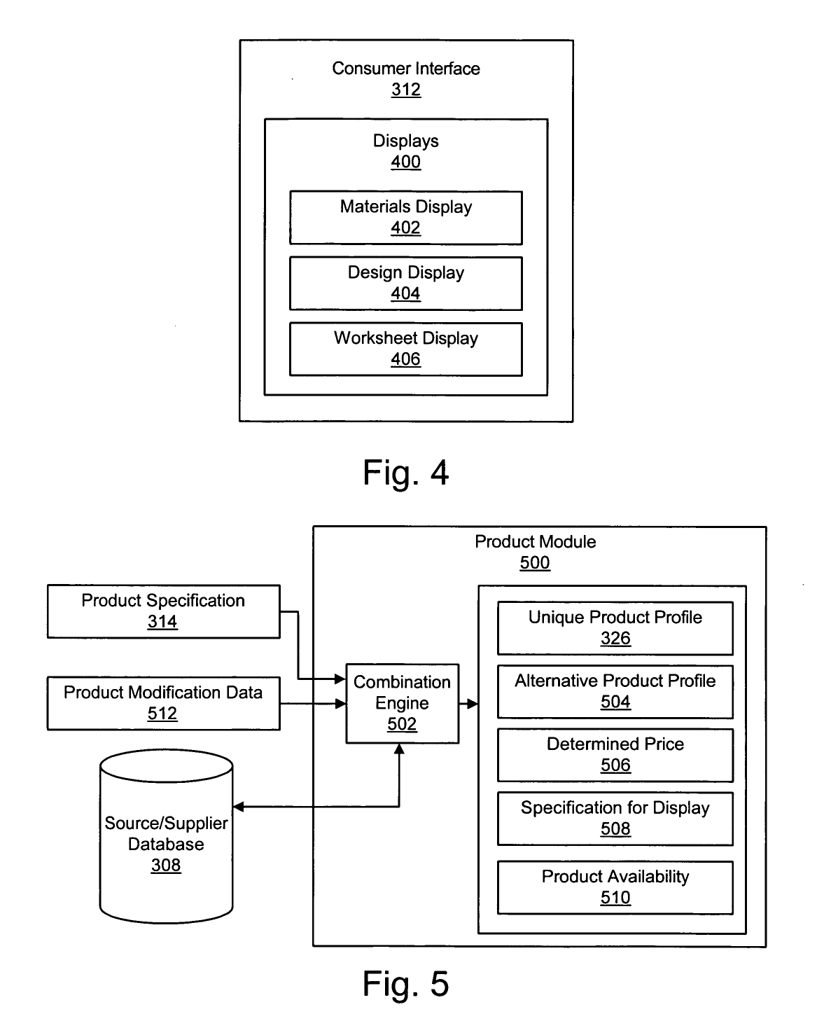

FIG. 4 illustrates one embodiment of a consumer interface 312 with a set of displays 400 in accordance with the present invention. In one embodiment, the consumer interface 312 presents a set of displays 400 to the consumer 210. The displays 400 may include a materials display 402, a design display 404, and a worksheet display 406. The consumer 210 may view the displays 400 in order to design a product and select materials. The set of displays 400 may reside in the input module 302 or in an outside database 308. The displays 400 may be presented in a logical sequence that encourages the consumer 210 to compile a pleasing and logical design and materials order that consists of enhanced safety options, structural integrity, attractiveness, timeliness, and cost effectiveness.

In one embodiment, the consumer interface 312 presents a series of windows and other Graphical User Interface (GUI) components. The windows may include images, graphics, charts, animations, interactive calculators, and the like to assist a user in choosing materials and designs to suit his/her needs. The GUI components may guide a user through the definition process to define a project profile 326. The windows and GUI components may be displayed on a variety of devices including a computer monitor, a television screen, or other projection device. In a further embodiment, the consumer interface 312 provides hard copies of the windows and/or product designs. The consumer interface 312 may comprise specialized computer software, specially designed hardware, or a web browser in certain embodiments.

The materials display 402 may include pictorial illustrations and descriptions. For example, if the consumer 210 is looking for landscape rocks, the illustrations may include pictures of the colors, sizes, shapes, and textures of the available classes of stone. Descriptions may explain the weight, hardness, durability, cost, and availability of the classes of stone. Alternatively, if the consumer 210 is purchasing a swimming pool, illustrations may include pictures of the various types of pool tile. Descriptions may describe the physical characteristics and price of the tile. In select embodiments, the materials display 402 is interactive, allowing the consumer 210 to manipulate and compare the displays.

The design display 404 may include pictorial illustrations of completed projects, such as a stone walkway, a rock garden, or a swimming pool, for example. The design display 404 may also include diagrams of available designs and written specifications. In a further embodiment, the design displays 404 may be interactive, allowing the consumer 210 to perform real time customization of the displayed design.

The worksheet display 406 may assist the consumer 210 in formulating the specifications for the new product or property improvement project. The worksheet display 406 may include diagrams, charts, and flow charts. In certain embodiments, the worksheet display 406 is interactive, allowing the consumer 210 to perform design and specification steps in real time. The worksheet display 406 may gather the needed information through a series of questions similar to an interview. The consumer 210 may enter input interactively via computer 110, adjusting the responses upon receiving feedback. In a further embodiment, the consumer 210 may respond to a hard-copy display including paper copies, photographic prints and/or slides.

FIG. 5 illustrates an alternative embodiment of a product module 500 in accordance with the present invention. The product module 500 as depicted includes a combination engine 502, a unique product profile 326, an alternative product profile 504, a determined price 506, a specification 508 for a display, and a product availability determination 510. The product module 500 communicates with a database 308 to receive source/supplier input 200 and specialty contractor input 202.

In one embodiment, the combination engine 502 combines the consumer input 204, including materials selection 236, design selection 238, and product specification 314, with information drawn from the source/supplier database 308. Information from the source/supplier database 308 may include the location of the material, mileage from the material source to the customer, supplier's current fees for the products, and the like.

For example, if a consumer selects a certain grade and color of alder for a hardwood floor, the combination engine 502 may extract from the source/supplier database 308 the information pertaining to sources or suppliers 206 of that particular alder. Such information may include color and shades, varieties of wood grain, hardness, dimensions and thickness of the planks, length of time cured, type of finish, product costs and shipping costs. In a further embodiment, the combination engine 502 may compare the suppliers 206 according to quality, price, and availability of the selected alder. The combination engine 502 may select particular suppliers 206 or distributors based on predefined criteria such as those located within a maximum distance from the customer's project site.

In one embodiment, the combination engine502 may prepare a product profile 326 based on the combination of contractor, consumer, and supplier data. In a further embodiment, the combination engine 502 may prepare a product profile 326 incorporating each applicable supplier. Alternatively, the combination engine 502 may prepare a product profile 207 based on a predefined number of the most promising suppliers 206.

In a further embodiment, the source/supplier database 308 may include proprietary, trade secret, and quality ratings for the products supplied. For example, many suppliers 206 claim to provide superior products, but without proof. The database 308 may include the results of product investigation, such as topsoil testing, for example. Topsoil pits may be represented within a display under names unique to the system. The combination engine 206 may then include the quality rating as a factor in determining a supplier 206 for quality rated materials.

In a further embodiment, the combination engine 502 may access the materials availability list 216 for the selected material from within the source/supplier database 308 and may include the time availability 510 of materials in the product profile 326. The combination engine 502 may also prepare an alternative product profile 504 including cost saving suggestions.

As mentioned above, the user may modify the product profile 326. Specifically, the user may provide product modification data 512, which is incorporated into the product profile 326. The product modification data 512 may include size, quantity, color, and material changes in certain embodiments. The product modification data 512 may be generated through successive iterations with the interview module 311, in certain embodiments, until the consumer 210 is satisfied with the product profile 326.

In certain embodiments, the product module 500 may further determine the specification 508 for the visual representation to present the unique product to the user. The specification 508 may correspond with the unique product profile 326.

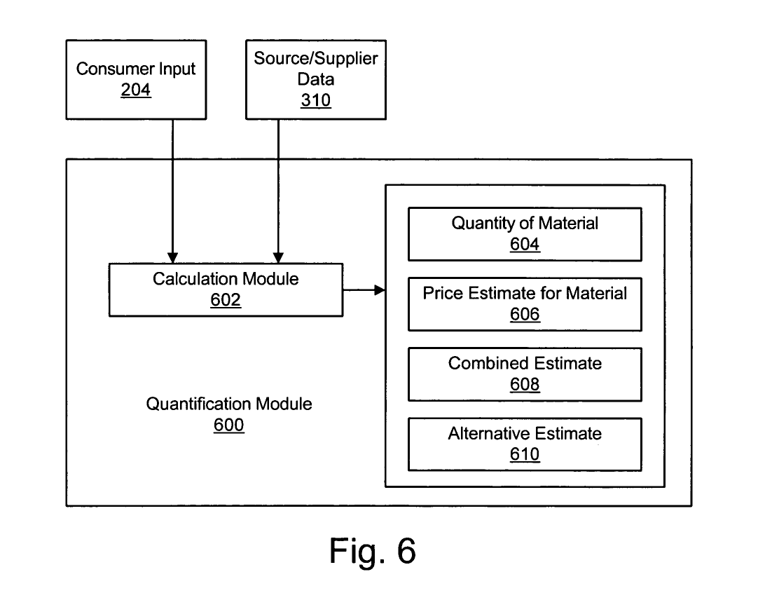

FIG. 6 illustrates one embodiment of a quantification module 600 in accordance with the present invention. The quantification module 600 may include a calculation module 602, a quantity of material determination 604, a price estimate for material 606, a combined estimate 608 for all materials, and an alternative estimate 610. The quantification module 600 may receive input 204 from the consumer 210 and input data 310 from the source 206 and/or the specialty contractor 208. In certain embodiments, the quantification module 600 receives the product specification 314. In a further embodiment, the quantification module 600 accesses the source/supplier database 308.

Based on the consumer input 204 received from the input module 302, the calculation module 602 may select the appropriate materials source from the database 308. In a further embodiment, the calculation module 602 may calculate the quantity of material 604 required based on the product specification 314. The calculation module 602 may also access the materials unit price lists 218 of the selected source and calculate the product price estimate 606 based on the quantity of material 604 required. The combined estimate 608 may include the price of all the materials combined. In certain embodiments, the calculation module 602 utilizes custom formulas designed to accurately determine proper quantities for the product based on the consumer input 204. In certain embodiments, the calculation module 502 may also prepare an alternative estimate 610 for the alternative profile 504 with cost saving suggestions or the like.

The calculation module 602 may be configured to determine a quantity based on the characteristics of a material, a supplier 206, or certain limitations. For example, a product specification 314 for a rock retaining wall may include dimension specification, rock type and shape, and the like. In one embodiment, the custom formula may include a standardized set of rock sizes. The standardized set of rock sizes may be based on shape, width, height, texture, and quality of the rock. A standardized set or a custom formula may also be based on limitations. For example, difficult access to a work site may dictate a limitation on the size of rocks that can be used.

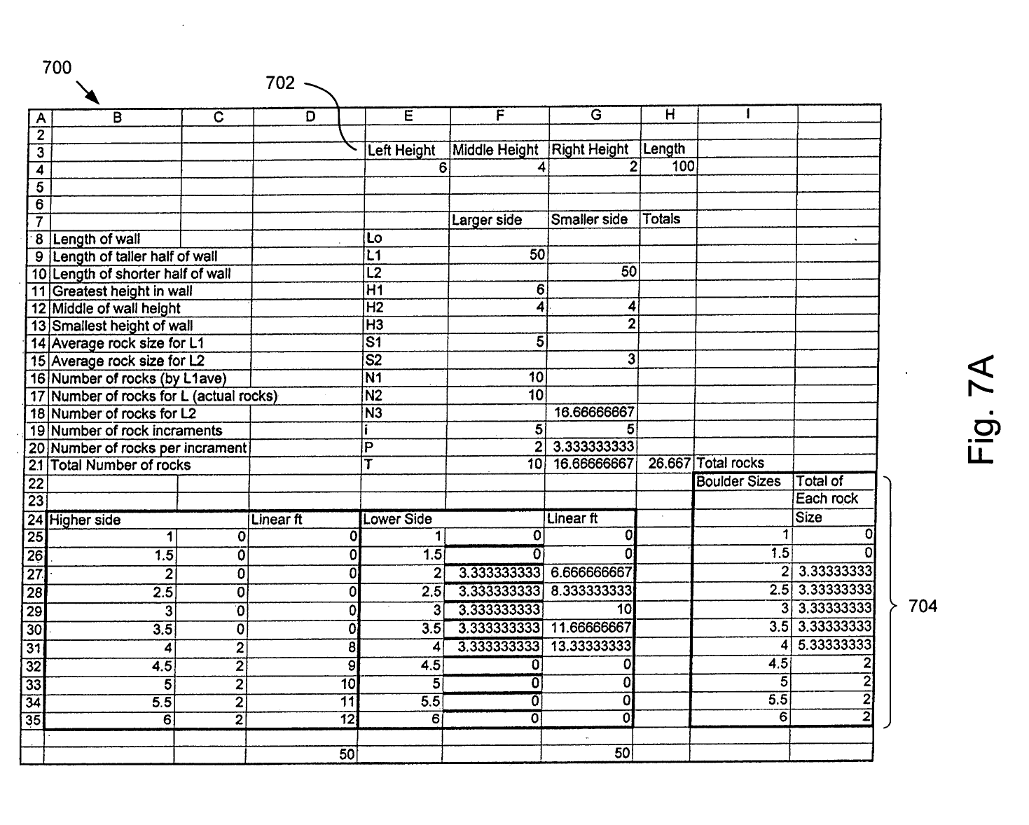

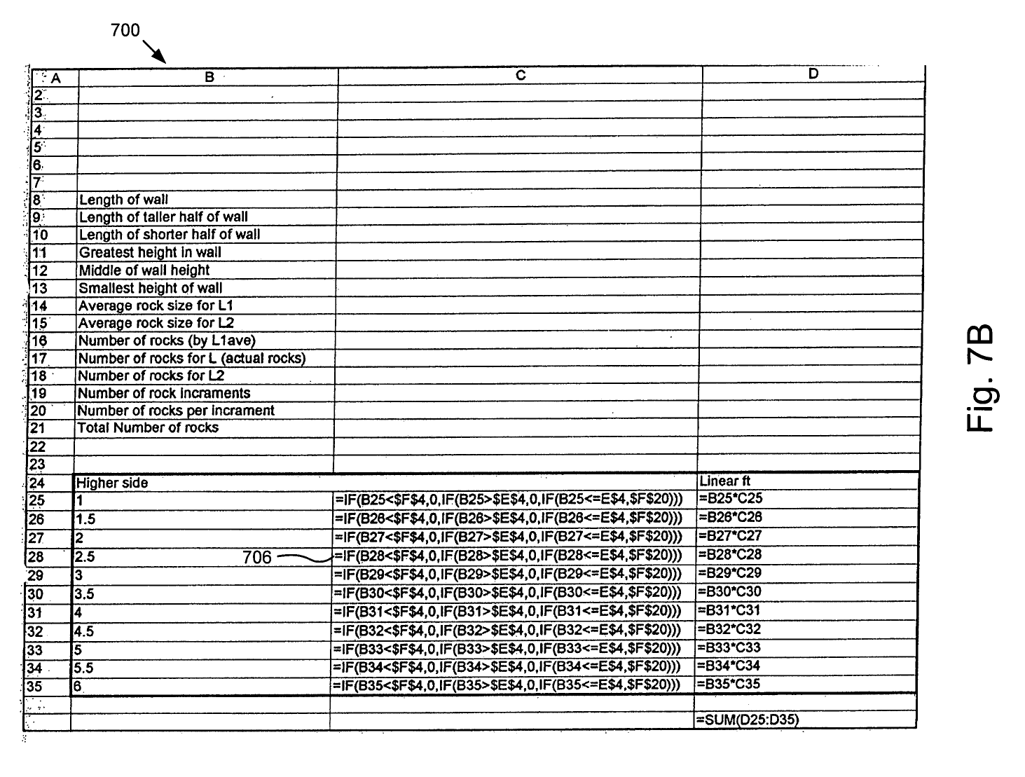

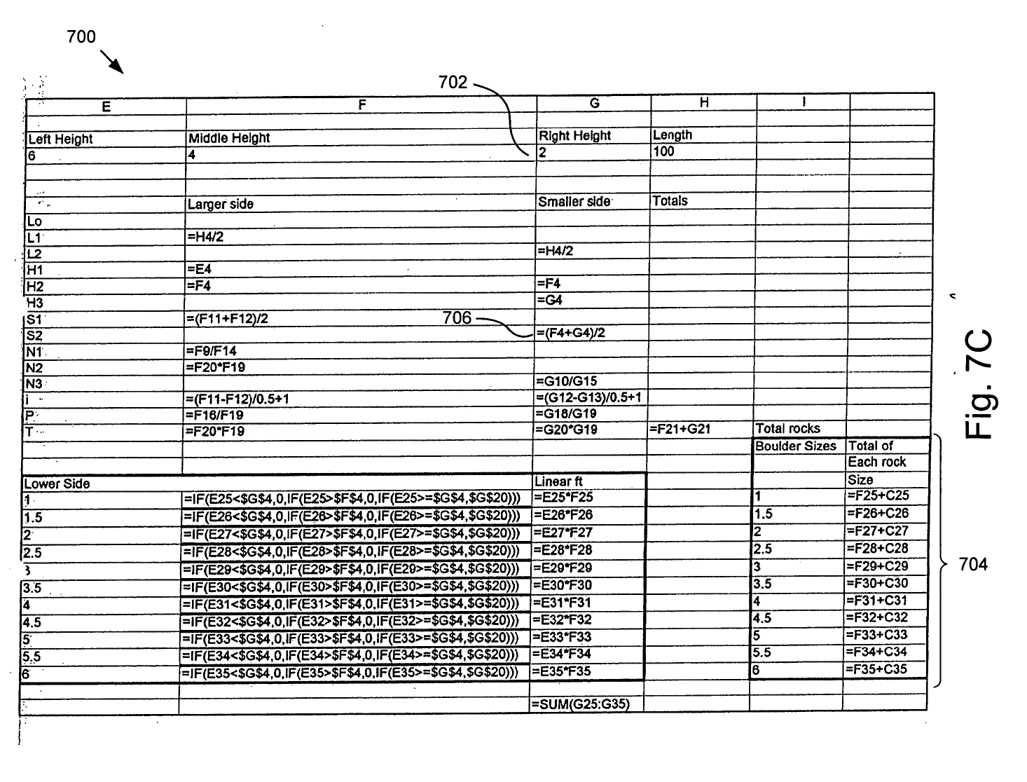

FIGS. 7A-7C illustrates one embodiment of a custom formula 700 for determining a quantity of material 604, particularly a quantity of rocks. FIG. 7A illustrates consumer input 206, such as dimension specifications 702, that may be calculated into the custom formula 700 to determine a quantity 704 of rocks for a corresponding size. FIGS. 7B-7C illustrate the custom formula 700 relative to cell input 706 for determining the quantity 704 of rocks.

Referring back to FIG. 6, the calculation module 602 subsequently may perform calculations to arrive at the estimated price 606 of the materials based on the quantity of material, the materials unit price list 218, and/or the customized formulas. For example, if a customer is building a pool, and selects tile A for the deck, tile B for the rim, and tile C for the bowl, the calculation module 602 may determine the number of pieces of each type of tile required based on the size of the deck, the depth of the rim, and the shape, size, and depth of the pool.

The quantification module 600 may identify each particular tile type in the materials catalogue 212, access the per unit price list 218, and for each of tiles A, B, and C, multiply the number of tile pieces by the per unit cost to arrive at the total materials cost 608 for the tile. If the consumer 210 were building a flagstone patio, the product specification 314 may include the size, shape, thickness, color and number of flagstones. The calculation module 602 may determine the price per unit 606 and a combined estimate 608 for all of the stones.

In a contemplated embodiment, a majority of the information in the product specification 314 is automatically calculated for the consumer 210. In certain embodiments, substantially all the information in product specification 314 and/or product profile 326 may be modified by the consumer 210 as desired. In one embodiment the calculation module 602 accesses the source location 220 and delivery costs 222 within the source/supplier database 308 and calculates a combined estimate 608 that includes the cost of shipping the materials to the delivery site from the source or supplier location. The calculation module 602 may arrive at the cost by multiplying the distance to the source by a per mile charge. Alternatively, an estimated charged may be hourly, based on an estimated time of arrival from a source location to a delivery site. In a further embodiment, the calculation module 208 may perform a similar calculation for the alternative product profile 504, yielding an alternative combined estimate 610.

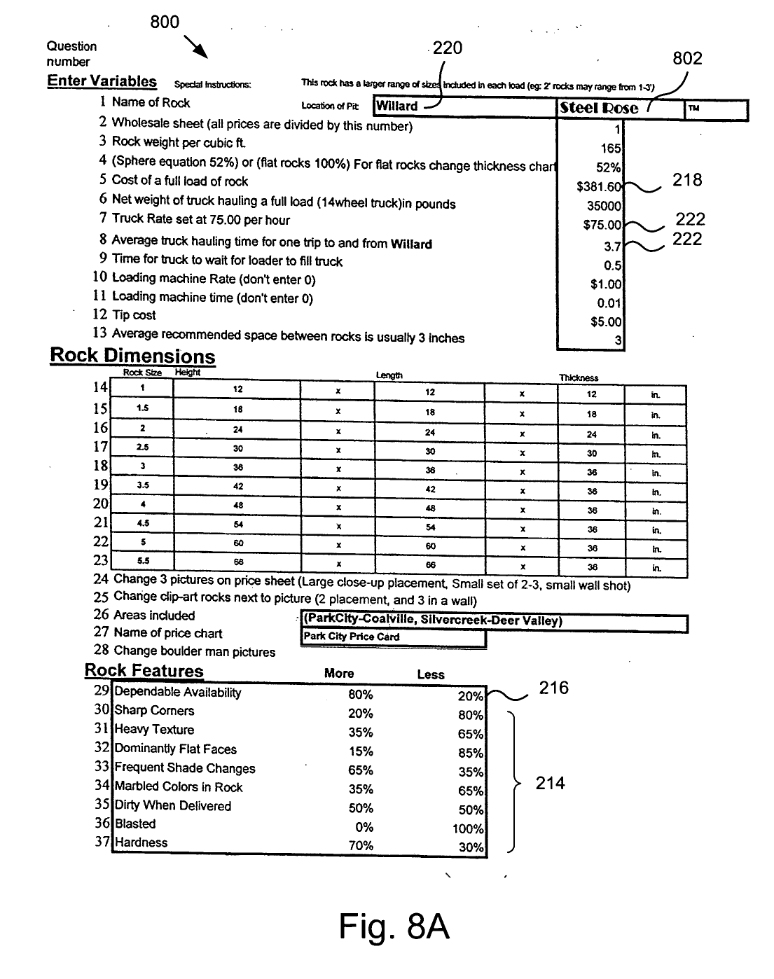

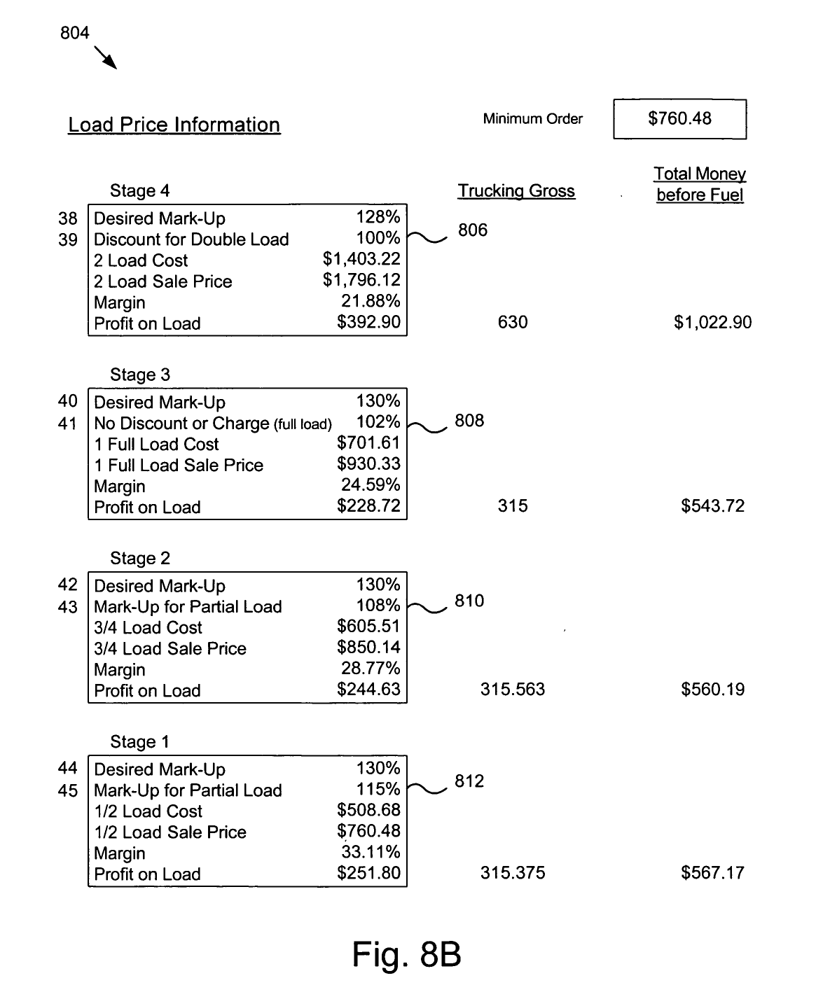

FIGS. 8A-8B illustrate one embodiment of a pricing/information list 800 for use to calculate a price for a quantity of material. In the depicted embodiment, the product is a stone called Steel Rose 802, and the pricing is based on a truck load size 218. The pricing/information list 800 may be supplied by the source/supplier 206 and may include materials characteristics 214, availability 216, materials price 218, source location 220, and delivery data 222. The delivery data 222 may include pricing information as well as time estimations.

FIG. 8B illustrates various pricing stages 804 for quantity and shipping costs. Pricing may include a stage four 806, a stage three 808, a stage two 806, and a stage one 812. Stage one 812 may represent a minimum allowable order with corresponding price mark-ups. Once a stage one 812 order is completed, additional material purchases may correspond to another stage 810, 808, 806. If a stage three 806 order is fulfilled, the consumer may have to fill another stage one 812 order to obtain additional material. Two stage three 806 orders must be completed to reach stage 4. In certain embodiments, the shipper and/or supplier 206 may combine partial load orders of individual consumers 210 to decrease shipping costs.

In an alternative embodiment, the pricing may be determined by a per unit price that may also be fulfilled in stages 804, based on size of material, quantity of order, and the like. In one embodiment, rocks are priced individually by size. An individual rock may be associated with a material charge as well as a placement charge. As the consumer 210 purchases enough rocks to fill a pricing stage 804, the price of the rock and the placement charge may be decreased accordingly. Alternatively the rock(s) may be priced by the square-face-footage, which may also be priced according to stages 804. Square footage orders may also be associated with a placement charge in certain embodiments.

In select embodiments, the pricing stages 804 for individual units and/or square-face-foot pricing, or the method for pricing, may be displayed to the user in conjunction with one or more visual representations or images. The pricing may be displayed in a worksheet display 406, in one embodiment, to inform the user how a product price is determined and to help the consumer understand how to make an appropriate product request.

In a contemplated embodiment, the display module 306 creates a graphical display of all calculations and variables used to arrive at a price estimate. The graphical display may include specific details such as the material pricing system, delivery vehicle details, delivery costs, transportation time estimates, a tip for the operator, labor costs, etc. In certain embodiments, the user may be able to modify one or more variables and receive updated calculations in real time.

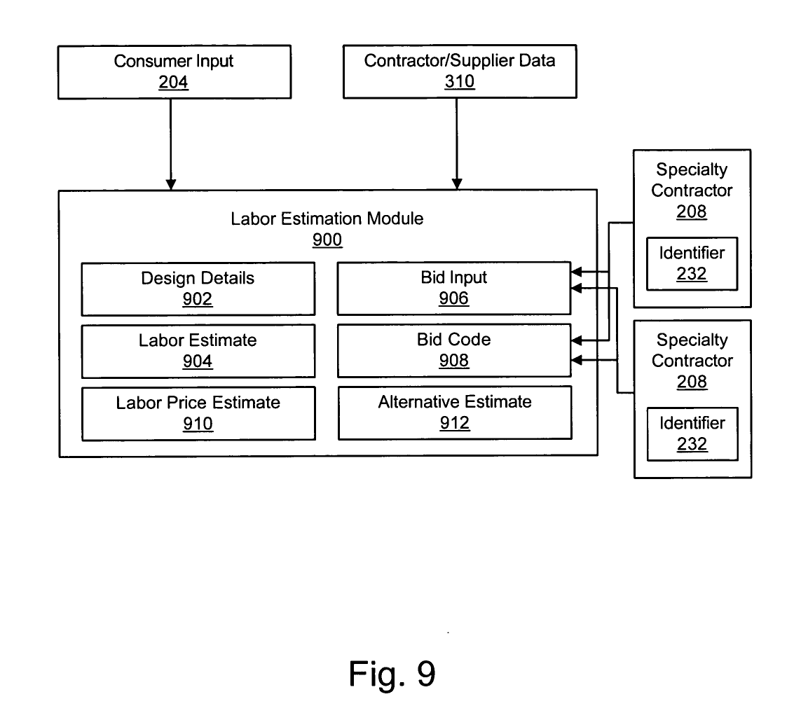

FIG. 9 illustrates one embodiment of a labor estimation module 900. The labor estimation module 900 may include design details 902, a labor estimate 904, a labor price estimate 910, a bid input 906, a bid code 908, and an alternative estimate 912. The labor estimation module 900 may receive input 204 from a consumer 210, data 310 from a database 308 or the like, and bid input 906 from one or more specialty contractors 209.

In one embodiment, a prospective customer seeking pricing information may be encouraged to enter a bid code 908, or “discount code,” obtained from a specialty contractor 208. In one embodiment, the bid code 908 is associated with a unique identifier 232, such as a contractor or landscaper's verifiable contracting license number, for example. If pricing information is not requested, a consumer 210 may be able to view a visual representation 330 of a product profile 326 without entering a bid code 908 in certain embodiments.

Each contractor 208 may control or determine a discount for the materials supplied to the consumer 210 through a series of codes 908. A contractor 208 may interview a consumer 210 in order to determine which code 908 to provide. For example, a first code 908 may signify that the materials, labor, delivery, and/or product should be priced at the contractor's cost. A second code 910 may signify a 5% markup, a third a 10% markup, and so forth. The contractor 208 will be credited with the designated markup. Those consumers 210 who choose to go around the contractor 208 to obtain the materials and the like may pay 20% extra in certain embodiments. In this manner, the contractor 208 may be provided with an incentive to refer customers to use the present invention for pricing and displaying a product.

When the consumer 210 uses or selects a certain contractor's code 908 or identifier 232, the specified contractor 208 may receive the design details 902 of the consumer's desired finished product. In one embodiment, the product profile 326 may be emailed or presented to the contractor 208. The product profile 326 may include design details 902 to enable the contractor 208 to build the product precisely as the consumer 210 designed it.

In a further embodiment, the user may be invited to answer a series of questions pertinent to the work involved. Certain questions may pertain to the product and its design and make-up. Others questions may relate to personal information and/or preferences. If a consumer 210 chooses to answer the questions, the consumer 210 may receive a free bid or the like from a “preferred” contractor 208.

The customer responses to the questions may be provided to each contractor 208 as a pre-screened and profiled list of jobs that are available. Contractors 208 may then request the address and any other information regarding a specific product or project. In a further embodiment, contractors 208 maybe charged a fee to receive consumer information. In addition, a contractor 208 may view a picture of the project site, the visual representation 330 of the product profile 326, and/or other information relative to a product. In one embodiment, the product and/or consumer information may be available to the contractor 208 through a secure website. The contractor 208 may be able to post a bid on line to perform the labor or to complete a product. The bid input 906, which may comprise one or more contractor bids, may be compiled in the product profile 326 or the alternative product profile 504 and presented to the consumer 210 for selection.

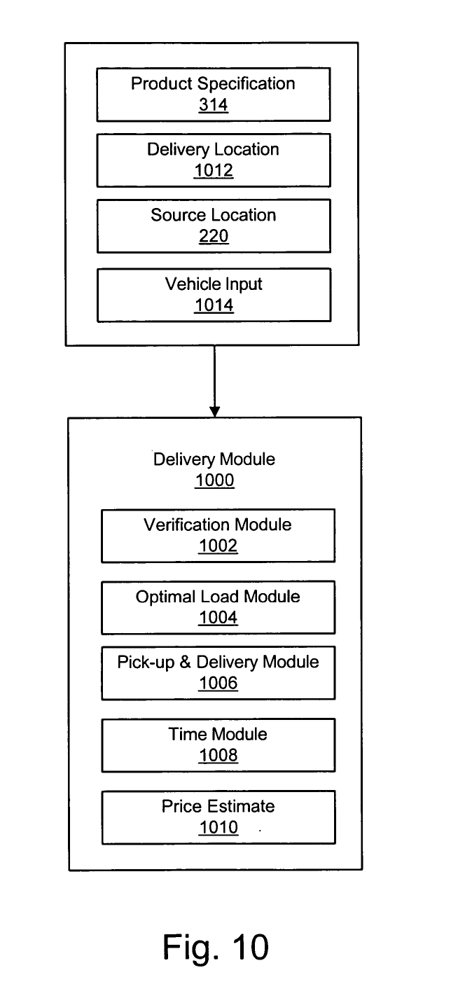

FIG. 10 illustrates one embodiment of a delivery module 1000. The delivery module 1000 may include a verification module 1002, an optimal load module 1004, a pick-up and delivery module 1006, a time module 1008, and a price estimate 1010. The delivery module 1000 may receive input relative to the product specification 314, the delivery location 1012, the source location 220, and vehicle input 1014. The delivery module 1000, in one embodiment, is a software program that may communicate with a network 106 to determine an optimal delivery method.

During a delivery or pick-up, the verification module 1002 may present the product request to the driver or person loading the vehicle and may require verification of each item loaded. The product requests may be itemized to ensure that each item is included in the pick-up. For example, if the consumer 210 is planning to build a retaining wall with one type of rock, each size of rock may have a checkbox to represent a rock required to complete the wall. When one rock is loaded, the attendant would mark the box to verify that that particular rock is loaded into the vehicle. In one embodiment, a checklist is displayed using a graphical user interface, which may be interactive to the attendant's response.

In one embodiment, an optimal load module 1004 instructs the attendant how best to load the vehicle. For example, if the load is a partial load, the optimal load module 1004 may instruct the attendant to load the truck bed near the truck or cab. If large heavy rocks are being loaded, the optimal load module 1004 may provide instructions to load the rocks in a pyramid shape. Alternatively, if the rocks are small, the instructions may guide the attendant to load the truck bed in layers. In one embodiment, the optimal load module 1004 may include a display illustrating an image of a truck and truck bed with an outline drawn on the truck bed to illustrate the optimal load for a particular product. Alternatively or in addition, a written description may be provided.

In certain embodiments, the optimal load module 1004 may calculate the estimated weight of the load. When the truck is loaded with the requested load, the truck may be weighed to verify the weight of the load. The actual weight may be compared with the estimated weight to verify the load. In one embodiment, the driver or attendant may be required to enter a weight verification before the delivery module 1000 or optimal load module 1004 will permit the driver to continue with the delivery.

In certain embodiments, the pick-up and delivery module 1006 organizes the routing of a delivery vehicle, such as a truck. A delivery truck or vehicle may be theoretically valued at a certain rate per hour. The rate may be billed or actualized, however, only when the vehicle is loaded and delivering a requested product. Thus, the distance a vehicle travels without a load, such as on the way to or from a source 220 or a delivery location 1012, represents a loss of money. By carefully routing the vehicles to schedule a drop off near a pickup, or a pickup or “back haul” near a drop off, the pick-up and delivery module 1006 minimizes the distance traveling without a load. In addition, the value of the truck increases as loads can be shared on a truck.

For example a geographical area may be divided into five sub-areas. If a truck begins a delivery route at sub-area #1, and then goes to sub-area #2, the pick-up and delivery module 1006 may identify a pick-up order in sub-area #2 which may need to be delivered to, for example, sub-area #3. The pick-up and delivery module 1006 may then attempt to identify a pick-up order in sub-area #3 that needs to be delivered back in sub-area #1, which may be the truck's home base.

The pick-up and delivery module 1006 may produce a routing schedule for the truck such as areas 1-2, 2-3, 3-1. Such a schedule optimizes use of the truck and limits the time the truck travels empty or partially filled. Thus, for example, a $75.00 per hour truck might attain many back-hauls resulting in an actual income of $125.00 per hour for the truck at the end of the day. In a further embodiment, consumers 210 may have the option to pay extra for delivery on a certain day, providing partial compensation for the loss of back haul income. Delivery according to the schedule produced by pick-up and delivery module 1006 may be more economical for a consumer 210 as well as the supplier 206 or contractor 208.

The time module 1008 may estimate a time associated with a pick-up or delivery, such as a delivery time or a driving time, for example. In certain embodiments, the time module 1008 time stamps a loading time, a transporting time, and a delivery time. The actual time may be recorded for reference to evaluate a driver and/or vehicle, or for providing future estimates that may be more accurate. The recorded time may be used to bill the consumer 210. Alternatively, the estimated time may be used to bill the consumer 210. As mentioned, the time may be associated with an hourly billing rate.

A price estimate 1010 may be determined from product and delivery estimates, such as load size, weight, source 220 and delivery locations 1012, vehicle input 1014, and time estimates. A price estimate 1010 may be the amount a supplier 206 is willing accept to for delivery of a product or the materials for a product. Estimates may be provided relative to past deliveries and product orders. Providing a price estimate for delivery 1010 enables the consumer 210 to budget for a product for final costs. As a result, the consumer 210 may modify a product order based off of one or more estimates that reflect as near as possible an actual product price.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

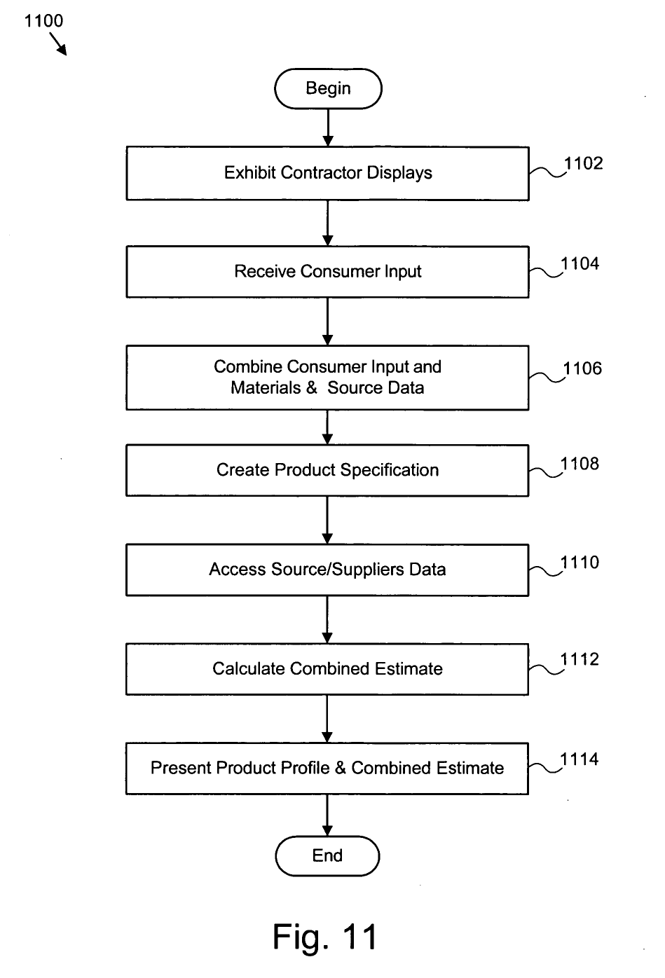

FIG. 11 illustrates a method 1100 for pricing and displaying a non-standardized product according to one embodiment of the present invention. Reference may be made to FIGS. 1-10 for illustrative purposes only and are not intended to limit the scope of the invention. As depicted, the method 1100 includes exhibiting 1102 contractor displays 400, receiving 1104 consumer input 204, combining 1106 consumer input and materials and source data, creating 1108 a product specification 314, accessing 1110 source/supplier data 310, calculating 1112 a combined estimate, and presenting 1114 a product profile 326 and combined estimate to a consumer 210.

In one embodiment, the interview module 311 and the consumer interface 312 of the input module 302 cooperate to exhibit 1102 the set of displays 400. The order in which the displays 400 are presented may be scripted. Alternatively, the order depends on selections made by the consumer 210 while interacting with the displays. Next, the interview module may receive 1104 the consumer input 204. The consumer 210 may select and modify a standard product or create an original product, by selecting a material type, color, shape, size, quality and the like, by responding to a worksheet, and/or by making modifications based on price or other considerations. The displays 400 may be displayed on a computer monitor 112 and the like, or the displays 400 may be included in a slide presentation, catalogue, workbook, in store display, or the like.

Subsequently, the input module 302 and/or the product module 304 may combine 1106 the consumer input 204 with relevant data 310 from the supplier/source 206 and/or contractor 208 to create 1108 a product specification 314, which may comprise the design and materials information for the product. The product module 304 may access 1110 a source/supplier database 308 to define the product profile 326.

Next, the product module 304 calculates 1112 a combined estimate, which, in one embodiment, is based on the quantity of material multiplied by the per unit price added to the shipping cost. Finally, the display module 306 presents 1114 the product profile 326 and combined estimate to the consumer 210. In certain embodiments, a visual representation of the product profile 326 is displayed.

In certain embodiments, a personal representative such as a sales representative, specialty contractor 208 or the like, may receive input from the consumer 210 and compile a product profile 326 and/or visual representation for display as well as a price estimate to present to the consumer 210. The personal representative may reference a quantification module 600, pricing module 322, delivery module 320, display module 306, or the like to compile the product profile 326 and/or the visual representation 330.

In one embodiment, a representative or the display module 306 or the like may select features of a product, such as, for example, specific upgrades to a home, and may display the features to the consumer 210 without revealing the pricing information. The representative may prefer to disclose the pricing information in a later presentation, such as in the controlled atmosphere of a design room and sales office. The price may be presented item by item, by groups of features, or as a total. In a further embodiment, the representative may present options that may be similar to the desired product, but less expensive than the customer's chosen features. By allowing the consumer 210 to create the product, without revealing the price, the representative may be able to sell more to the consumer 210 than the consumer 210 had originally planned, either because the consumer 210 was uninformed about certain features, or because the consumer is determined to have an advanced product.

The present invention solves the deficiencies of the prior art by allowing a consumer 210 unfamiliar with property improvement such as landscaping to interactively view the available material, designs, and variations in print, over the internet, or through various presentation techniques. Using the present invention, the consumer 210 may select materials, choose and modify a design, enter measurements, receive a precisely calculated price and quantity estimate, modify the design and receive a new estimate, and place an order.

The present invention accesses databases including data regarding materials, availability, distance to the material supply, and shipping costs. For example, in one embodiment the present invention accesses a database with information on all of the stone quarries within a reasonable distance from a prospective job site. In a further embodiment, the database includes information on qualities such as color, hardness, compositions, shape, and durability.

In one embodiment, the customer views this information and selects material based on such qualities as form, color, thickness, and durability. In a further embodiment, the consumer 210 refines the selection by selecting a specific source of supply for natural materials that vary according to the source. A further embodiment selects the source of supply based on price constraints and on an interplay between material composition and function. Limestone, for example, is not recommended for retaining walls except in desert climates.

The information provided to the consumer 210 on available choices of materials and design may be combined with customer input on material and project specifications and with database information from sources, suppliers, shippers, and the like into a project profile. The project profile may provide the basis for calculations of the quantity of materials and the total price. The calculation may also be made on a per-unit basis, for example, per-rock, rather than a truck load basis, thus avoiding the inconsistency occasioned by variations in truck load sizes.

In various embodiments, the price calculation is displayed to the consumer 210. Cost-saving modifications for the project profile may also be displayed to the client. The client may have the opportunity to modify the project specifications of the project profile in response to the price and receive a recalculated price based on the modifications. The modification and calculation processes may be repeated through successive iterations until the customer is satisfied with the combination of design, quality, and price.

When the project profile and price have been determined the customer may view a contract having some important elements such as waiver provisions illustrated by graphics or animation. The customer may then finalize the order.

A further embodiment generates a work order and a shipping bill of lading for the supplier of material. The work and shipping orders may specify individual pieces of material in detail, for example, the exact type, size, and number of rocks ordered.

Although most of the specific illustrations reference real property improvement using natural or uniquely irregular materials in custom projects, other embodiments may include both new and used non-real property applications. These might include machinery, trailers, RV's or other types of mechanical devices that could be designed using graphic displays, could generate cost estimates, could be sold, and could be custom-built in accordance with the present invention.

Applications may extend further to all materials handling industries. Specific examples may include concrete, gravel, asphalt, and topsoil. Conventional web sites that handle these products typically provide, at best, a crude cubic yardage calculator and would benefit from a graphic interface to help sell features and from the simple graphic interview process used to accomplish calculations. For example, a supplier could visually portray an enhanced fiber mesh added to concrete for strength or calcium chloride added in the winter when concrete needs to dry faster in order to inform or persuade consumer. Graphics depicting the intended shape of the area designed assist with the identification and calculation of such additives and features. Thus, the utility of the present invention extends to almost any industry handling any type of materials that have to be measured, weighed, priced, or quantified.

In one embodiment, the present invention may be used to allow business customers to selectively choose options for a software sales system. Customers may use the present invention to design and price options for complex software systems including a customized version of the present invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for pricing and displaying a non-standardized product, the apparatus comprising:
an input module configured to receive input specified by a consumer;
a product module configured to determine a unique product derived from the input and to determine a price associated with the unique product; and
a display module configured to display a visual representation of the unique product and the determined price.

2. The apparatus of claim 1, wherein the product module further comprises a quantification module configured to determine a quantity of material required to produce the unique product and an estimated cost for the material.

3. The apparatus of claim 1, wherein the product module further comprises a labor estimation module configured to estimate a cost for labor required to produce the unique product.

4. The apparatus of claim 3, wherein the labor estimation module is configured to receive bid input from a plurality of specialty contractors.

5. The apparatus of claim 4, wherein each specialty contractor is associated with a unique identifier and bid input is associated with a bid code and wherein the input specified by a consumer comprises at least one of the unique identifier and the bid code.

6. The apparatus of claim 5, wherein the bid code corresponds to an increment of a base value.

7. The system of claim 1, wherein the product module further comprises a delivery module configured to determine an optimal delivery method and to calculate a cost for delivery of the unique product.

8. The apparatus of claim 1, wherein the determined price comprises at least one of a cost for material, a cost for labor, a combined cost for material and labor, a cost for delivery, and a combined cost for material, labor, and delivery.

9. The apparatus of claim 1, wherein the display module further includes a customization module configured to customize a graphic to resemble the unique product.

10. The apparatus of claim 1, wherein the input comprises at least one of a design selection, a design modification, a dimension selection, a dimension modification, a labor bid selection, a labor bid modification, a material type selection, and a material type modification.

11. A signal bearing medium tangibly embodying a program of machine-readable instructions executable by a digital processing apparatus to perform an operation for pricing and displaying a non-standardized product, the operation comprising:
receiving input specified by a consumer;
determining a unique product derived from the input;
determining a price associated with the unique product; and
displaying a visual representation of the unique product and the determined price.

12. The signal bearing medium of claim 11, wherein the instructions further comprise an operation to determine an optimal delivery method to deliver the unique product.

13. The signal bearing medium of claim 12, wherein the instructions further comprise an operation to receive input relative to the unique product and input relative to a vehicle and to calculate an optimal configuration for loading the unique product into the vehicle for transportation.

14. The signal bearing medium of claim 13, wherein the instructions further comprise an operation to verify the weight and load configuration of the unique product within the vehicle.

15. The signal bearing medium of claim 12, wherein the instructions further comprise an operation to determine at least one of a first pick-up and a first delivery and scheduling at least one of a second pick-up and a second delivery within a designated geographic proximity.

16. The signal bearing medium of claim 12, wherein the instructions further comprise an operation to time stamp a loading time of the unique product, to time stamp a transporting time of the unique product, and to time stamp a delivery time of the unique product.

17. A method for pricing and displaying a non-standardized product, the method comprising:
receiving input specified by a consumer;
determining a unique product derived from the input;
determining a price associated with the unique product; and
displaying a visual representation of the unique product and the determined price.

18. The method of claim 17, wherein the unique product comprises at least one rock for placement in a landscape design.

19. The method of claim 17, further comprising determining an alternative product to the unique product.

20. The method of claim 17, further comprising searching a database for material availability and providing an estimate for availability of the unique product.

21. A system for pricing and displaying a non-standardized product, the system comprising:
a computer network;
a computer connected to the network;
a server configured to communicate with the computer through the computer network and to search a database;
an input module configured to receive input specified by a consumer;
a product module configured to determine a unique product derived from the input and to determine a price associated with the unique product;
a display module configured to display a visual representation of the unique product and the determined price; and
a monitor configured to display the visual representation of the unique product and the determined price.
